(19) United States
(12) Patent Application Publication
(10) Pub. No.: US 2026/0320512 A1
(43) Pub. Date: Oct. 15, 2026

(54) SYSTEM AND METHOD FOR CROSS-SUBSIDIARY COLLABORATION IN FINANCIAL INDUSTRY

(71) Applicant: Charles Lap San CHAN, Taipei (TW)

(72) Inventor: Charles Lap San CHAN, Taipei (TW)

(21) Appl. No.: 19/635,164

(22) Filed: Mar. 31, 2026

(30) Foreign Application Priority Data
Apr. 9, 2025 (TW) 114113341

(51) Int. Cl. G06Q 10/0631

(52) U.S. Cl. CPC G06Q 10/0631

(57) ABSTRACT

A system and method for cross-subsidiary collaboration in the financial industry comprising a plurality of subsidiary servers and an intermediary server. Each of the subsidiary servers includes at least one specialist terminal and an artificial intelligence (AI) assistant robot. The intermediary server comprises a processor and a memory configured to perform: receiving a support request from the specialist terminal of a subsidiary; coordinating allocation of human and system resources among the plurality of subsidiaries; establishing and managing a communication group including users and specialists of the plurality of subsidiaries; and tracking and recording statuses and results of cross-subsidiary business referrals. The disclosure achieves intelligent cross-subsidiary collaboration, secure data transmission, and effective business referral tracking.

### CROSS-REFERENCE TO RELATED APPLICATION

This application claims the priority benefit of Taiwan application No. 114113341, filed on Apr. 9, 2025. The entirety of the above-mentioned patent application is hereby incorporated by reference herein and made a part of this specification.

### BACKGROUND OF THE INVENTION

### Field of the Invention

The disclosure relates to a system and method for cross-subsidiary collaboration in the financial industry, and more particularly, to a collaboration system and method capable of integrating human resources and knowledge systems of various subsidiaries within a financial holding group, securely managing communication groups through a resource scheduling algorithm, and tracking business referrals.

### Description of the Prior Art

In recent years, a general financial holding company typically owns a plurality of subsidiaries, such as a banking company, an insurance company, and a securities company, etc. Each subsidiary has its own professional field and service items. However, under the traditional financial service model, the subsidiaries often operate independently and lack an effective communication and collaboration mechanism among each other. This operational model has numerous disadvantages.

First, regarding knowledge sharing, although each subsidiary has built its own exclusive AI-assisted system, these systems are often restricted to internal use within the respective subsidiary. For example, when a bank's customer asks insurance-related questions, the bank specialist cannot directly access the AI-assisted system of the insurance company to obtain professional information, resulting in an inability to provide the customer with accurate answers in a timely manner.

Second, regarding human resource scheduling, when a customer is negotiating business with a specialist of a certain subsidiary, if the negotiation involves the professional field of another subsidiary, the existing systems cannot immediately and effectively bring in professionals from the other subsidiary to participate in the discussion. Such limitations prevent cross-subsidiary services from proceeding smoothly, degrade the customer experience, and may lead to missed potential business opportunities.

Furthermore, regarding customer data protection, when there is a need to refer a customer to another subsidiary, existing systems lack a secure and compliant data transfer mechanism. This may lead to violations of personal data protection regulations or improper disclosure of customer data, thereby increasing legal risks.

Finally, regarding business referral rewards, existing systems cannot effectively track and record the business development status after cross-subsidiary referrals. This results in a lack of motivation for frontline personnel to refer business, as they cannot accurately grasp the transaction status after the referral and cannot obtain corresponding referral bonuses, thereby affecting the synergistic benefits within the group.

The various problems mentioned above not only reduce the overall operational efficiency of the financial holding company but also limit its ability to provide comprehensive financial services. Therefore, there is an urgent need for a system capable of integrating the resources of various subsidiaries and conducting secure and effective cross-subsidiary collaboration, so as to improve service quality and create greater operational benefits.

### BRIEF SUMMARY OF THE INVENTION

An objective of the disclosure is to provide a system and method for cross-subsidiary collaboration in the financial industry, which utilizes an intermediary server as a core control hub to connect specialist terminals and AI assistant robots of various subsidiaries, and achieves technical dynamic allocation of computing resources and human resources across subsidiaries through underlying resource scheduling algorithms and availability data.

Another objective of the disclosure is to provide a system and method for cross-subsidiary collaboration in the financial industry, capable of ensuring data transmission security and access rights isolation among different subsidiaries by generating a specific assignment record and an access control list (ACL), meeting the regulatory requirements of the financial industry, and realizing system-level traceability of business referrals.

To achieve the above objectives, the disclosure provides a system for cross-subsidiary collaboration in the financial industry, comprising: a plurality of subsidiary servers, each subsidiary server comprising: at least one specialist terminal; and an artificial intelligence (AI) assistant robot; an intermediary server, comprising: a processor; and a memory storing program codes, wherein the program codes, when executed by the processor, cause the processor to perform: receiving a support request from a specialist terminal of a first subsidiary, the support request comprising a business type tag; retrieving availability data of the plurality of subsidiaries from a database, wherein the availability data comprises a current connection status and scheduling data of the at least one specialist terminal, real-time system load data of the AI assistant robot, and a corresponding professional matching tag; comparing the business type tag of the support request with the availability data through a resource allocation algorithm, to determine assigning at least one specialist terminal of a second subsidiary or an AI assistant robot of a second subsidiary, and generating an assignment record comprising a system address and having an access control right setting in the database; executing a message routing procedure based on the system address and the right setting of the assignment record, to establish and manage a communication group including users and specialists from the plurality of subsidiaries, wherein the message routing procedure limits data read/write rights of different subsidiary endpoints in the communication group according to the right setting to achieve data isolation; and tracking and recording statuses and results of cross-subsidiary business referrals; wherein the intermediary server is connected to the plurality of subsidiary servers via a network.

The disclosure provides a method for cross-subsidiary collaboration in the financial industry, comprising: receiving, by an intermediary server, a support request from a specialist terminal of a first subsidiary, the support request comprising a business type tag; retrieving, by the intermediary server, availability data of a plurality of subsidiaries from a database, wherein the availability data comprises a current connection status and scheduling data of at least one specialist terminal, real-time system load data of an artificial intelligence (AI) assistant robot, and a corresponding professional matching tag; comparing, by the intermediary server through a resource allocation algorithm, the business type tag of the support request with the availability data to determine assigning at least one specialist terminal of a second subsidiary or an AI assistant robot of a second subsidiary, and generating, in the database, an assignment record comprising a system address and having an access control right setting; executing, by the intermediary server, a message routing procedure based on the system address and the right setting of the assignment record, to establish and manage a communication group including users and specialists of the plurality of subsidiaries, wherein the message routing procedure limits data read/write rights of different subsidiary endpoints in the communication group according to the right setting to achieve data isolation; and tracking and recording, by the intermediary server, statuses and results of cross-subsidiary business referrals; wherein the intermediary server is connected to a plurality of subsidiary servers via a network, and each of the subsidiary servers comprises at least one specialist terminal and an AI assistant robot.

### BRIEF DESCRIPTION OF THE DRAWINGS

FIG. 1 shows a system architecture diagram of a cross-subsidiary collaboration system 100 in the financial industry according to a preferred embodiment of the disclosure.

FIG. 2 shows a method flowchart of a cross-subsidiary collaboration method in the financial industry according to a first embodiment of the disclosure.

FIG. 3 shows a method flowchart of a cross-subsidiary collaboration method in the financial industry according to a second embodiment of the disclosure.

### DETAILED DESCRIPTION OF THE INVENTION

The features, advantages, or similar expressions referred to in this specification do not imply that all of the features and advantages that may be realized by the disclosure should be included in any single embodiment of the disclosure. Rather, it should be understood that the expressions regarding features and advantages refer to specific features, advantages, or characteristics described in connection with an embodiment as being included in at least one embodiment of the disclosure. Therefore, discussions of features and advantages, and similar expressions, throughout this specification may, but do not necessarily, refer to the same embodiment.

The aforementioned features and advantages of the disclosure will become more apparent from the following description and the appended claims, or by practicing the embodiments of the disclosure as described below.

In order to make the description of the present disclosure more thorough and complete, illustrative descriptions of embodiments and specific examples of the present application are provided below; however, these are not the only forms in which the embodiments of the disclosure may be implemented or utilized. The embodiments encompass the features of various specific embodiments, as well as the methods and sequences of steps for constructing and operating these specific embodiments. Nevertheless, other embodiments may be employed to achieve the same or equivalent functions and sequences of steps.

The disclosure provides a system and method for cross-subsidiary collaboration in the financial industry. Its primary objective is to utilize an intermediary server as a core control hub to connect specialist terminals and artificial intelligence (AI) assistant robots of various subsidiaries, thereby achieving effective allocation of human and system resources across the subsidiaries. In addition, the system and method of the disclosure can ensure the security of data transmission among different subsidiaries, comply with the regulatory requirements of the financial industry that prohibit the arbitrary transfer of customer data to other subsidiaries, and realize the traceability of business referrals, effectively improving the management efficiency of cross-subsidiary collaboration.

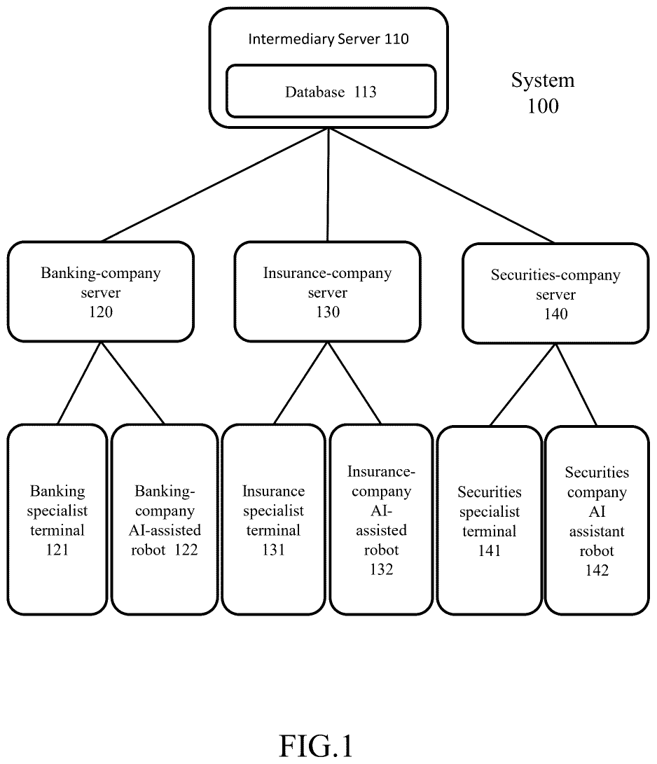

Referring to FIG. 1, a system architecture diagram of a cross-subsidiary collaboration system 100 in the financial industry according to a preferred embodiment of the disclosure is shown. The system 100 comprises an intermediary server 110 and a plurality of subsidiary servers 120, 130, and 140, wherein these servers are connected to each other via a network. In this embodiment, these subsidiary servers are sequentially a banking company server 120, an insurance company server 130, and a securities company server 140, but the disclosure is not limited thereto. The network may be a local area network (LAN), a wide area network (WAN), the Internet, or any combination thereof.

The intermediary server 110 comprises a processor 111 and a memory 112. The processor 111 may be a central processing unit (CPU), a graphics processing unit (GPU), or an application-specific integrated circuit (ASIC). The memory 112 may include a random access memory (RAM) and a read-only memory (ROM) for storing an operating system and application programs. The intermediary server 110 further comprises a database 113 for storing user data, communication records, and business tracking information. In other embodiments, the database 113 may also be distributively disposed in the plurality of subsidiary servers 120, 130, and 140.

The structures of the subsidiary servers are basically the same, and the banking company server 120 is taken as an example for description. The server comprises at least one bank specialist terminal 121 and a banking company AI assistant robot 122. The bank specialist terminal 121 may be a personal computer or a mobile device installed with a dedicated application program, and the application program provides a graphical user interface (GUI) including functions such as login verification, instant messaging, and file transfer. The banking company AI assistant robot 122 is an intelligent system developed based on deep learning technology, which adopts a language model to process natural language input, and is capable of retrieving relevant professional information through a knowledge graph to provide answers.

The structure of the securities company server 140 is also similar to that of the banking company server 120. It comprises at least one securities specialist terminal 141 and a securities company AI assistant robot 142. The securities specialist terminal 141 provides operational interfaces for securities trading, order placement, and portfolio management; while the securities company AI assistant robot 142 pre-stores knowledge graphs of securities trading regulations, real-time market quote analysis, and technical indicators of various financial products, configured to assist securities specialists in quickly responding to customer inquiries regarding stock market, bond market, or fund investments.

In the disclosure, the artificial intelligence (AI) assistant robot of each subsidiary is a trained artificial intelligence model. The model is trained through deep learning technology using a massive amount of domain knowledge and historical business data of the subsidiary. Specifically, the AI assistant robot of the banking company is trained with banking business knowledge such as deposits, loans, and foreign exchange; the AI assistant robot of the insurance company is trained with insurance professional knowledge such as life insurance, health insurance, and accident insurance; and the AI assistant robot of the securities company is trained with securities-related knowledge such as stock trading, fund investment, and the bond market.

These AI assistant robots adopt large language models (LLMs) as a foundation and are combined with knowledge graph technology to construct an exclusive knowledge base for the subsidiary. The knowledge graph contains structured knowledge such as product information, service processes, and regulatory requirements of the subsidiary, enabling the robot to understand the correlations between business concepts and provide more accurate answers. For example, when discussing retirement financial planning, the AI assistant robot of the insurance company can understand the relationships among related concepts such as annuity insurance, medical insurance, and long-term care, thereby providing comprehensive protection recommendations.

Each AI assistant robot is equipped with a natural language processing (NLP) module capable of understanding the question intentions of the specialist or the customer. In addition, the robot has contextual understanding capability, is able to maintain dialogue coherence in multi-turn conversations, remember important information mentioned in previous contexts, and provide answers that better meet scenario requirements.

When a first subsidiary specialist (e.g., a bank specialist) is serving a customer on the first subsidiary specialist terminal 121, if support from a second subsidiary (e.g., an insurance company) is needed, the specialist may send a support request by clicking a “seek support” button on an interface. The support request indicates whether the first subsidiary specialist chooses to require support provided by the AI assistant robot of the second subsidiary or chooses to require participation of a second subsidiary specialist for support, and includes a corresponding business type tag.

To achieve precise resource scheduling across subsidiaries, the intermediary server 110 of the disclosure continuously monitors and collects “Availability Data” stored in the database 113. The availability data is a structured dataset specifically comprising: (1) hardware and real-time system load data, such as CPU utilization, memory occupancy, current thread count, and network bandwidth latency of each subsidiary server and the AI assistant robot; (2) personnel availability data, such as the current connection status (online/offline/busy) of each specialist terminal, calendar scheduling periods, and the number of active connections being handled; and (3) professional matching tags, representing technical tags of professional fields corresponding to respective system resources and specialists. Through this dynamically updated availability data, the system transforms abstract human coordination into a concrete server resource scheduling problem.

When the intermediary server 110 receives the support request, the processor 111 does not merely perform simple message transmission, but executes a resource allocation algorithm (e.g., a resource load balancing and matching algorithm). First, the system performs natural language processing (NLP) on the content of the support request, extracts keywords, and maps them to preset business type tags. Next, the algorithm calculates an “assignment weight score” based on the above-mentioned “availability data”. For example, if a CPU load of the insurance company AI assistant robot 132 is lower than a preset threshold (e.g., 60%), and its knowledge graph contains nodes matching the business type tag, the system assigns it a higher weight score. Conversely, if the system load is excessively high, the algorithm redirects the request to an insurance specialist terminal 131 having an idle scheduling block. This mechanism ensures the optimization of computing resources during cross-system queries and prevents a single server from being overloaded.

Once the algorithm completes the allocation decision, the intermediary server 110 generates an “Assignment Record” having a specific data structure and writes it into the database 113. The assignment record comprises: a universally unique identifier (UUID), a request source IP address, a target resource IP address or robot API endpoint (i.e., the system address), an allocation timestamp, and an authorization access token. The intermediary server 110 then establishes a cross-subsidiary communication group through a network routing protocol based on the assignment record. The system also executes a message routing procedure by strictly limiting data read/write rights (i.e., the right setting) of different subsidiary endpoints in the communication group through an access control list (ACL) defined in the assignment record, thereby technically realizing data isolation and referral tracking in compliance with financial regulations.

During the establishment process of the communication group, the intermediary server 110 may first create a group record in the database 113, comprising information such as a group identifier, a creation time, and a member list. In situations where the communication group needs to cross subsidiaries, the system may further record a complete message routing chain in the database 113, comprising information such as a sender, a receiver, a timestamp, and a message type, to facilitate subsequent tracking and auditing. For example, initially, the bank specialist terminal 121 and an external customer terminal (not shown in the figures) establish a banking company communication group for communication between the two, and the banking company communication group is assigned by the intermediary server 110 to be established and managed by the banking company server 120. When assistance from an insurance specialist is needed, the bank specialist terminal 121 sends a support request to the intermediary server 110, and then the insurance specialist terminal 131 is added to the original banking company communication group, such that the banking company communication group constitutes a communication among three parties.

When the insurance company specialist needs to have a private conversation with the customer, upon obtaining the customer's consent, the insurance specialist terminal 131 may issue a request to the intermediary server 110 to establish an insurance company communication group. The intermediary server 110 assigns the insurance company server 130 to establish and manage a new insurance company communication group. The insurance company communication group only includes two members: the insurance company specialist terminal and the customer terminal, such that all subsequent conversation content and customer data are directly stored in the insurance company server 130 to ensure the privacy and security of the data. Meanwhile, the original three-party communication group (i.e., the banking company communication group including the bank specialist, the insurance specialist, and the customer) remains in operation for cross-departmental coordination when necessary. The intermediary server 110 records the association between the two groups in the database 113, but does not store the conversation content of the insurance company communication group. This design not only protects the privacy of customer data but also maintains the flexibility of cross-departmental collaboration.

Regarding business tracking, when a business referral occurs, the system 100 creates a referral record in the database 113, comprising information such as a referral time, a referrer, and a receiver. Each subsequent business status update is recorded as an event in the referral record to form a complete business trajectory. The system 100 automatically calculates a referral bonus based on these referral records, and the calculation result is periodically pushed to a human resource system for bonus distribution.

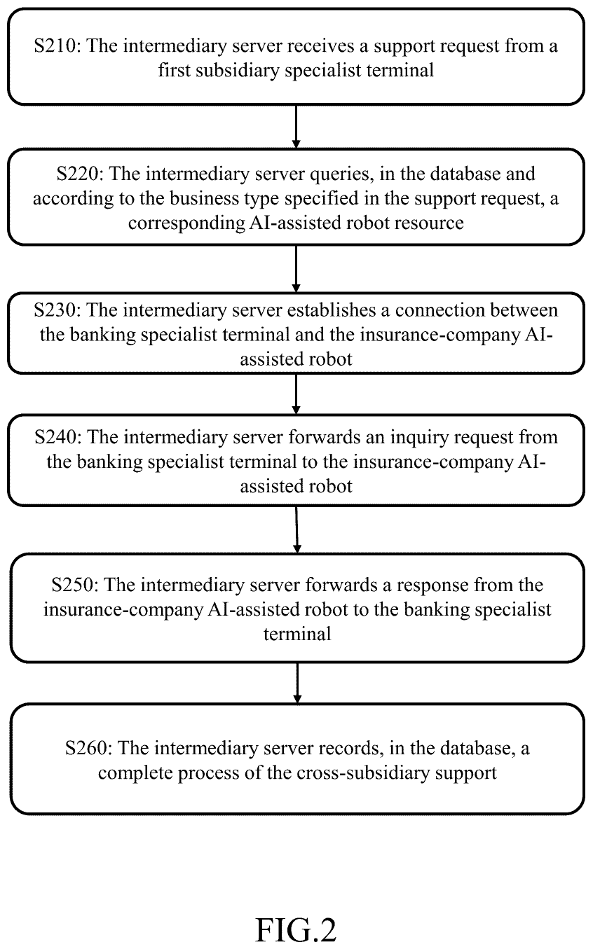

Referring to FIG. 2, a method flowchart of a cross-subsidiary collaboration method in the financial industry according to a first embodiment of the disclosure is shown. This embodiment illustrates a situation where a first subsidiary specialist requests an artificial intelligence (AI) assistant robot to provide support. The method comprises the following steps:

Step S210: the intermediary server 110 receives a support request from the first subsidiary specialist terminal. For example, when a bank specialist is serving a customer on the bank specialist terminal 121, if it is necessary to understand specific insurance product information, the support request may be sent through an “AI consultation support” button on an interface. The support request explicitly specifies the need for support from the AI assistant robot and includes information such as a business type (e.g., insurance product consultation).

Step S220: the intermediary server 110 queries corresponding AI assistant robot resources in the database 113 according to the business type specified in the support request. In this example, since the request involves insurance business, the intermediary server 110 checks an availability status of the insurance company AI assistant robot 132.

Step S230: the intermediary server 110 establishes a connection between the bank specialist terminal 121 and the insurance company AI assistant robot 132. After the connection is established, the system records relevant information of this connection in the database 113.

Step S240: the intermediary server 110 forwards an inquiry request of the bank specialist terminal 121 to the insurance company AI assistant robot 132. The AI assistant robot trained in the insurance professional field understands the question intention through a natural language processing (NLP) module and retrieves relevant information from its knowledge graph.

Step S250: the intermediary server 110 forwards a reply of the insurance company AI assistant robot 132 to the bank specialist terminal 121. The reply content includes the requested insurance product information. This process may involve multi-turn dialogues until the bank specialist obtains the required information.

Step S260: the intermediary server 110 records a complete process of this cross-departmental support in the database 113, including information such as a support request time, consultation content, and reply content.

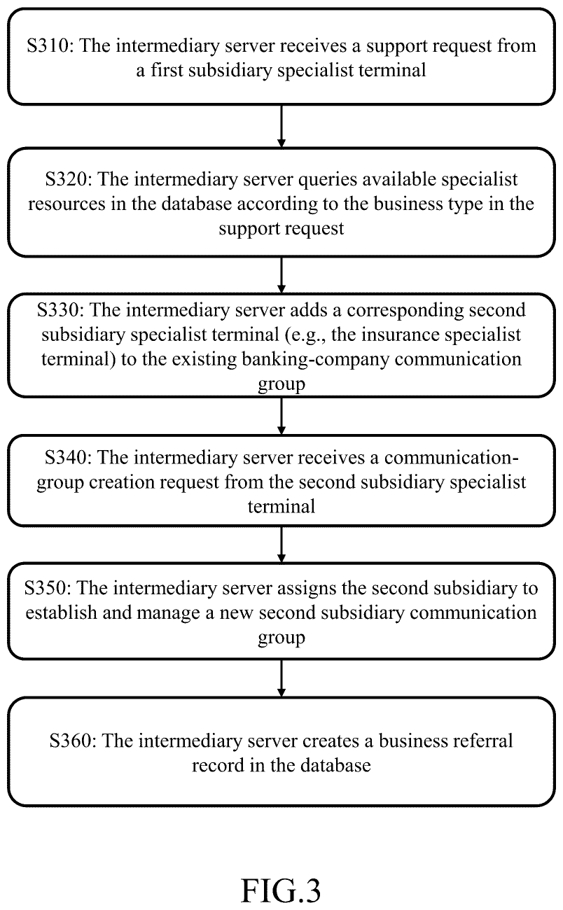

Referring to FIG. 3, a method flowchart of a cross-subsidiary collaboration method in the financial industry according to a second embodiment of the disclosure is shown. This embodiment illustrates a situation where a first subsidiary specialist requests a specialist of another subsidiary to directly participate in support. The method comprises the following steps:

Step S310: the intermediary server 110 receives a support request from the first subsidiary specialist terminal (the bank specialist terminal 121). The support request indicates that the participation of a specialist of another subsidiary in the support is needed, and includes a business type of the required support. For example, when a customer, via a customer terminal, and a bank specialist, via the bank specialist terminal 121, discuss financial planning in a banking company communication group and the customer additionally expresses interest in insurance products, the bank specialist may indicate the need for assistance from an insurance specialist in the support request.

Step S320: the intermediary server 110 queries available specialist resources in the database 113 according to the business type in the support request. The system 100 considers a plurality of factors to select an appropriate specialist, including a professional field of the specialist, current availability, and a service rating. Such intelligent resource allocation ensures that the most suitable service can be provided to the customer;

Step S330: the intermediary server 110 adds a corresponding subsidiary specialist (e.g., an insurance specialist of an insurance company) to the original banking company communication group. The communication group originally included the bank specialist terminal 121 and the customer terminal, and by adding the specialist of another subsidiary, a three-party communication platform is formed.

Step S340: the intermediary server 110 receives a communication group establishment request from the specialist terminal of another subsidiary. When the specialist of another subsidiary (e.g., the insurance specialist of the insurance company) needs to have a deeper business discussion with the customer, or needs to handle privacy-related information, a request to establish a dedicated communication group may be proposed. This request requires the customer's consent before subsequent processing can proceed.

Step S350: the intermediary server 110 assigns another subsidiary server (e.g., the insurance company server) to establish and manage a new subsidiary communication group (e.g., an insurance company communication group). This assignment process comprises authorization of rights, allocation of resources, and setting of related configurations. The intermediary server 110 records establishment information of this new communication group in the database 113 and maintains an association with the original communication group (the banking company communication group). This dedicated two-party communication group provides a secure environment, enabling the specialist to discuss more specific business details with the customer. All communication content is directly stored in the subsidiary server to ensure data privacy and security. At the same time, the original three-party communication group remains in operation and may be used for situations requiring cross-departmental coordination. Such a dual-track design not only guarantees data security but also maintains the flexibility of cross-departmental collaboration.

Step S360: the intermediary server 110 creates a business referral record in the database 113, comprising information such as a referral time, a referring bank specialist, and a receiving securities specialist. Subsequent business status updates are kept on record and used for performance statistics and bonus calculation.

The following content will describe an application scenario of the disclosure to assist in understanding the disclosure. For example, a bank customer, Mr. Wang, establishes a banking company communication group with the bank specialist terminal 121 via his customer terminal, and discusses his investment and financial planning with Bank Specialist Lee in the banking company communication group. During the communication process, Mr. Wang mentions an interest in retirement insurance planning. Bank Specialist Lee immediately sends a support request to the intermediary server 110 by clicking an “AI consultation support” button through the interface of the bank specialist terminal 121, to seek assistance from the insurance company AI assistant robot 132.

The insurance company AI assistant robot 132 retrieves relevant professional information via its knowledge graph, provides preliminary suggestions regarding Mr. Wang's retirement insurance planning, and then the intermediary server 110 forwards the reply of the insurance company AI assistant robot 132 to the bank specialist terminal 121.

Thereafter, since Mr. Wang expresses an intention to deeply understand insurance products, Bank Specialist Lee again clicks a “seek support” button through the interface of the bank specialist terminal 121 to send a request requiring support from an insurance specialist.

After receiving the support request, the intermediary server 110 queries available specialist resources in the database 113, and selects Insurance Specialist Lin to join the original banking company communication group. After initial communication and confirming the necessity for further detailed discussion, Insurance Specialist Lin, upon obtaining Mr. Wang's consent, may issue a request to the intermediary server 110 via the insurance specialist terminal 131 to establish an insurance company communication group. Then, the intermediary server 110 assigns the insurance company server 130 to establish and manage a new insurance company communication group. The newly established insurance company communication group only includes the insurance specialist terminal 131 and Mr. Wang's customer terminal, such that all subsequent conversation content and customer data will be directly stored in the insurance company server 130.

Meanwhile, the original banking company communication group continues to operate for cross-departmental coordination when necessary. The intermediary server 110 records the complete business referral process in the database 113, including information such as a referral time, the referring bank specialist, and the receiving insurance specialist, which is used for subsequent performance statistics and bonus calculation.

While various examples of the disclosed technology have been described above, it should be understood that they have been presented by way of example only, and not of limitation. Likewise, the various figures may depict an example architecture or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to a person skilled in the art how alternative functional, logical or physical partitioning and configurations can be implemented to implement the desired features of the technology disclosed herein. Furthermore, with regard to flow diagrams, operational descriptions, and method claims, the order in which the steps are presented herein shall not mandate that various embodiments be implemented to perform the recited functionality in the same order unless the context dictates otherwise.

The above description is merely illustrative of the preferred embodiments of the disclosure and is not intended to limit the scope of implementation of the disclosure. Therefore, any equivalent variations and modifications made based on the shapes, structures, features, and spirits described in the claims of the disclosure should be included within the scope of the claims of the disclosure.

What is claimed is:

1. A system for cross-subsidiary collaboration in the financial industry, the system comprising:
a plurality of subsidiary servers, each of the subsidiary servers comprising at least one specialist terminal and an artificial intelligence (AI) assistant robot; and
an intermediary server, comprising:
a processor; and
a memory storing program codes, wherein the program codes, when executed by the processor, cause the processor to perform:
receiving a support request from a specialist terminal of a first subsidiary, the support request comprising a business type tag;
retrieving availability data of a plurality of subsidiaries from a database, wherein the availability data comprises a current connection status and scheduling data of the at least one specialist terminal, real-time system load data of the AI assistant robot, and a corresponding professional matching tag;
comparing the business type tag of the support request with the availability data through a resource allocation algorithm to determine assigning at least one specialist terminal of a second subsidiary or the AI assistant robot of the second subsidiary, and generating an assignment record comprising a system address and having an access control right setting in the database;
executing a message routing procedure based on the system address and the access control right setting of the assignment record, to establish and manage a communication group including users and specialists of the plurality of subsidiaries, wherein the message routing procedure limits data read/write rights of different subsidiary endpoints in the communication group according to the access control right setting to achieve data isolation; and
tracking and recording statuses and results of cross-subsidiary business referrals;
wherein the intermediary server is connected to the plurality of subsidiary servers via a network.

2. The system of claim 1, wherein the plurality of subsidiary servers comprise: a banking company server, an insurance company server, and a securities company server.

3. The system of claim 1, wherein the program codes, when executed by the processor, further cause the processor to perform:
establishing a network connection between the specialist terminal of the first subsidiary and the AI assistant robot of the second subsidiary according to the assignment record;
forwarding an inquiry request of the specialist terminal of the first subsidiary to the AI assistant robot of the second subsidiary, wherein the inquiry request relates to a business type of the second subsidiary; and
forwarding a reply of the AI assistant robot of the second subsidiary to the specialist terminal of the first subsidiary via the message routing procedure.

4. The system of claim 1, wherein the program codes, when executed by the processor, further cause the processor to perform:
adding the specialist terminal of the second subsidiary to a first subsidiary communication group according to the access control right setting of the assignment record;
wherein the first subsidiary communication group comprises the specialist terminal of the first subsidiary, the specialist terminal of the second subsidiary, and an external customer terminal; and
wherein the first subsidiary communication group is established and managed by a first subsidiary server.

5. The system of claim 4, wherein the program codes, when executed by the processor, further cause the processor to perform:
receiving a communication group establishment request from the specialist terminal of the second subsidiary; and
assigning a second subsidiary server to establish and manage a second subsidiary communication group, wherein the second subsidiary communication group only includes the specialist terminal of the second subsidiary and the external customer terminal.

6. A method for cross-subsidiary collaboration in the financial industry, comprising:
receiving, by an intermediary server, a support request from a specialist terminal of a first subsidiary, the support request comprising a business type tag;
retrieving, by the intermediary server, availability data of a plurality of subsidiaries from a database, wherein the availability data comprises a current connection status and scheduling data of at least one specialist terminal, real-time system load data of an artificial intelligence (AI) assistant robot, and a corresponding professional matching tag;
comparing, by the intermediary server through a resource allocation algorithm, the business type tag of the support request with the availability data to determine assigning at least one specialist terminal of a second subsidiary or an AI assistant robot of a second subsidiary, and generating, in the database, an assignment record comprising a system address and having an access control right setting;
executing, by the intermediary server, a message routing procedure based on the system address and the access control right setting of the assignment record, to establish and manage a communication group including users and specialists of the plurality of subsidiaries, wherein the message routing procedure limits data read/write rights of different subsidiary endpoints in the communication group according to the access control right setting to achieve data isolation; and
tracking and recording, by the intermediary server, statuses and results of cross-subsidiary business referrals;
wherein the intermediary server is connected to a plurality of subsidiary servers via a network, and each of the subsidiary servers comprises at least one specialist terminal and an AI assistant robot.

7. The method of claim 6, further comprising:
establishing, by the intermediary server, a connection between the specialist terminal of the first subsidiary and the AI assistant robot of the second subsidiary according to the assignment record;
forwarding, by the intermediary server, an inquiry request of the specialist terminal of the first subsidiary to the AI assistant robot of the second subsidiary, wherein the inquiry request relates to a business type of the second subsidiary; and
forwarding, by the intermediary server, a reply of the AI assistant robot of the second subsidiary to the specialist terminal of the first subsidiary via the message routing procedure.

8. The method of claim 6, further comprising:
adding, by the intermediary server, the specialist terminal of the second subsidiary to a first subsidiary communication group according to the access control right setting of the assignment record;
wherein the first subsidiary communication group comprises the specialist terminal of the first subsidiary, the specialist terminal of the second subsidiary, and an external customer terminal; and
wherein the first subsidiary communication group is established and managed by a first subsidiary server.

9. The method of claim 8, further comprising:
receiving, by the intermediary server, a communication group establishment request from the specialist terminal of the second subsidiary; and
assigning, by the intermediary server, a second subsidiary server to establish and manage a second subsidiary communication group, wherein the second subsidiary communication group only includes the specialist terminal of the second subsidiary and the external customer terminal.
